(19) United States
(12) Patent Application Publication
(10) Pub. No.: US 2008/0201032 A1
(43) Pub. Date: Aug. 21, 2008

(54) VEHICLE DIAGNOSTIC CODE COMMUNICATION DEVICE AND A METHOD FOR TRANSMITTING DIAGNOSTIC DATA UTILIZING THE VEHICLE DIAGNOSTIC CODE COMMUNICATION DEVICE

(76) Inventors: Salem A. Fayyad, Grand Blanc, MI (US); Imtiaz Zafar, Sterling Heights, MI (US); Carelton Williams, Belleville, MI (US)

Correspondence Address: CANTOR COLBURN, LLP, 20 Church Street, 22nd Floor, Hartford, CT, 06103, US

(21) Appl. No.: 11/675,174

(22) Filed: Feb. 15, 2007

(51) Int. Cl. G01M 17/00

(52) U.S. Cl. 701/29

(57) ABSTRACT

A vehicle diagnostic code communication device and a method for transmitting diagnostic data utilizing the vehicle diagnostic code communication device are provided. The vehicle diagnostic code communication device includes a diagnostic link connector configured to receive signals indicating a diagnostic code associated with vehicle operation and a microprocessor operably coupled to the diagnostic link connector. The microprocessor is configured to determine at least one of diagnostic textural data and diagnostic audio data based on the diagnostic code and to induce an RF transmitter to transmit a first RF signal having at least one of the diagnostic textual data and the diagnostic audio data.

### BACKGROUND

This application relates to a vehicle diagnostic code communication device and a method for transmitting diagnostic data utilizing the vehicle diagnostic code communication device.

A diagnostic code reader device has been utilized to retrieve diagnostic codes from an engine control module. A drawback with the diagnostic code reader device is that an operator may not be able to understand a meaning of the retrieved diagnostic codes. Further, since the diagnostic code reader device coupled to a connector under the vehicle dashboard, a display screen on the device may not be clearly visible to a vehicle operator while operating the vehicle.

Accordingly, the invention herein have recognized a need for vehicle diagnostic code communication device that minimizes and/or eliminates the above mentioned deficiencies.

### SUMMARY

A vehicle diagnostic code communication device in accordance with an exemplary embodiment is provided. The vehicle diagnostic code communication device includes a diagnostic link connector configured to receive signals indicating a diagnostic code associated with vehicle operation. The vehicle diagnostic code communication device further includes a microprocessor being operably coupled to the diagnostic link connector. The microprocessor is configured to determine at least one of diagnostic textual data and diagnostic audio data based on the diagnostic code. The vehicle diagnostic code communication device further includes a RF transmitter being operably coupled to the microprocessor. The microprocessor is further configured to induce the RF transmitter to transmit a RF signal having at least one of the diagnostic textual data and the diagnostic audio data.

A method for transmitting diagnostic data utilizing a vehicle diagnostic code communication device in accordance with another exemplary embodiment is provided the vehicle diagnostic code communication device includes a diagnostic link connector, a RF transmitter, a microprocessor operably coupled to the diagnostic link connector and the RF transmitter. The method includes receiving a diagnostic code at a diagnostic link connector. The method further includes determining at least one of diagnostic textural data and diagnostic audio data based on the diagnostic code, utilizing the microprocessor. The method further includes inducing the RF transmitter to transmit a RF signal having at least one of the diagnostic textural data and the diagnostic audio data, utilizing the microprocessor.

### BRIEF DESCRIPTION OF THE DRAWINGS

FIG. 1 is a schematic of a vehicle diagnostic code communication system having a vehicle diagnostic code communication device in accordance with an exemplary embodiment;

FIG. 2 is a schematic of a ratio unit utilized in the vehicle diagnostic code communication system of FIG. 1;

FIG. 3 is a schematic of a display device of the radio unit;

FIG. 4 is a schematic of a database utilized in the vehicle diagnostic code communication system of FIG. 1; and

FIGS. 5-7 are flowcharts of a method for transmitting diagnostic data utilizing the vehicle diagnostic code communication system of FIG. 1 in accordance with another exemplary embodiment.

### DETAILED DESCRIPTION OF EXEMPLARY EMBODIMENTS

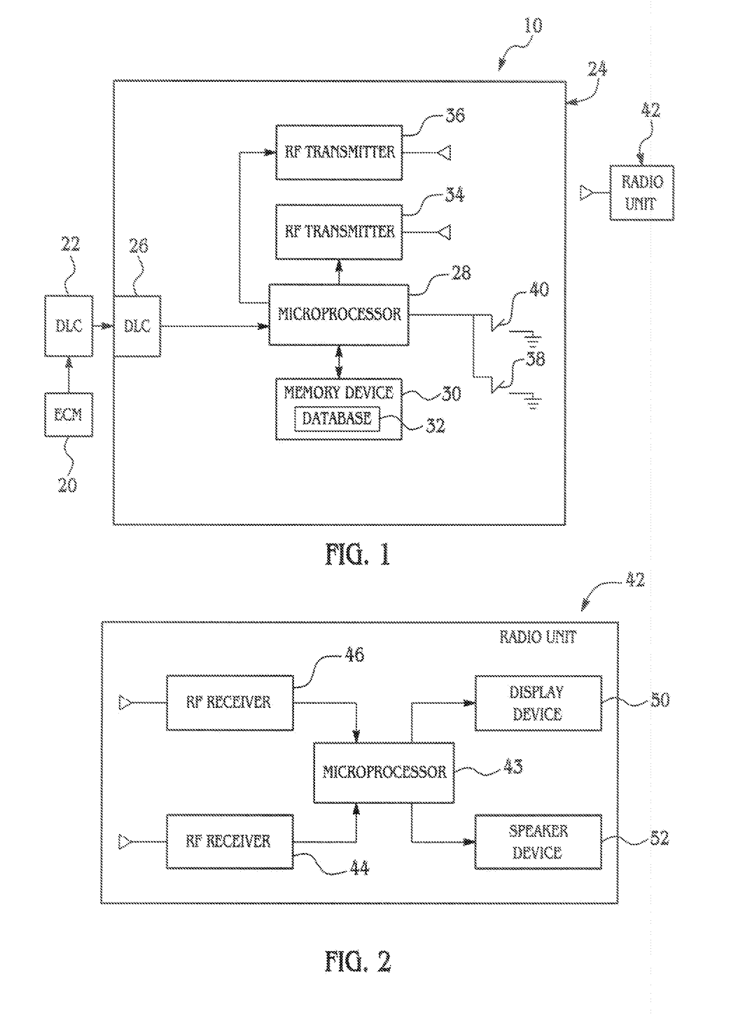

Referring to FIG. 1, a vehicle diagnostic code communication system 10 for transmitting diagnostic information associated with a vehicle is shown. The vehicle diagnostic code communication system 10 includes an engine control module 20, a diagnostic link connector 22, a vehicle diagnostic code communication device 24, and a radio unit 42.

The engine control module 20 is configured to generate signals having diagnostic codes indicative of vehicle engine operation. The module 20 sends the signals to the diagnostic link connector 22.

The diagnostic link connector 22 is operably coupled to the engine control module 20. The diagnostic link connector 22 receives signals having diagnostic codes from the engine control module 20 and sends the signals to the vehicle diagnostic code communication device 24 via a diagnostic link connector 26.

The vehicle diagnostic code communication device 24 is provided to receive signals having diagnostic codes, and to transmit RF signals having diagnostic textual data and diagnostic audio data relating to the diagnostic codes. The vehicle diagnostic code communication device 24 includes the diagnostic link connector 26 configured to receive the signals indicating diagnostic codes from the diagnostic link connector 22. The device 24 further includes a microprocessor 28 operably coupled to the diagnostic link connector 26. The microprocessor 28 is configured to determine at least one of: (i) diagnostic textual data, and (ii) diagnostic audio data based on the diagnostic code of the received signal.

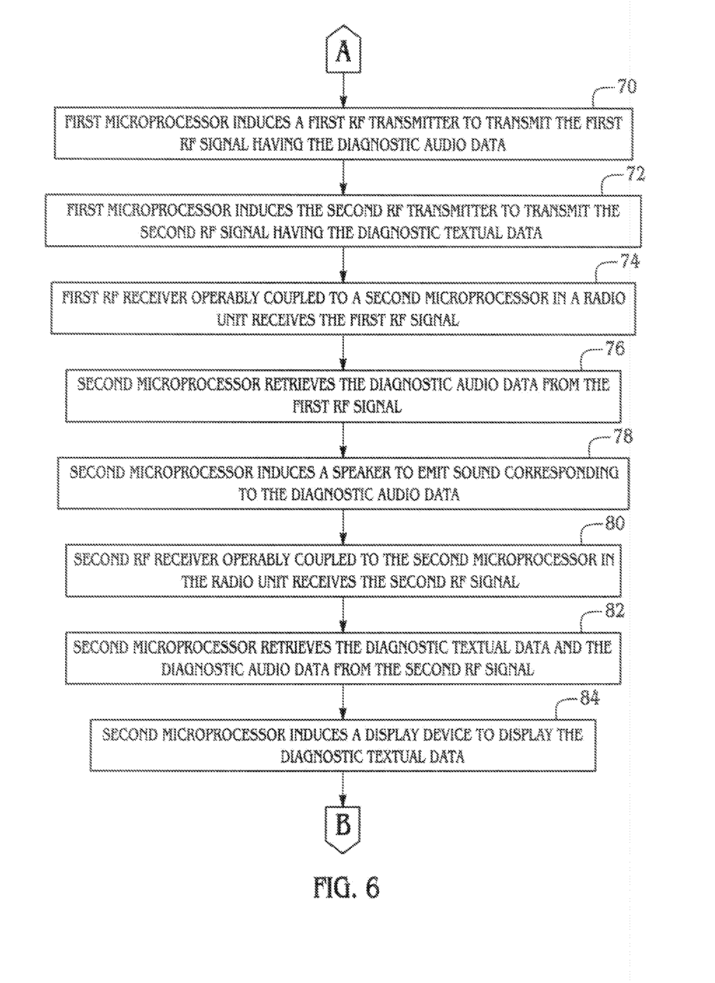

Referring to FIG. 4, a database 32 utilized by the vehicle diagnostic code communication device 24 is shown. In particular, the microprocessor 28 determines the diagnostic textual data and the diagnostic audio data by accessing a memory device 30 having the database 32. As shown, the database 32 includes a record having the diagnostic code “014, ” the diagnostic textual data “low coolant. ” and diagnostic audio data stored in a file “low.cooland.wav.” The database 32 further includes a record having the diagnostic code “016,” the diagnostic textual data “low emissions value,” and diagnostic audio data stored in a file “low.emissions.valve.wav/” The database 32 further includes a record having the diagnostic code “018,” the diagnostic textual data “low oil,” and diagnostic audio data stored in a file “low.oil.wav.”

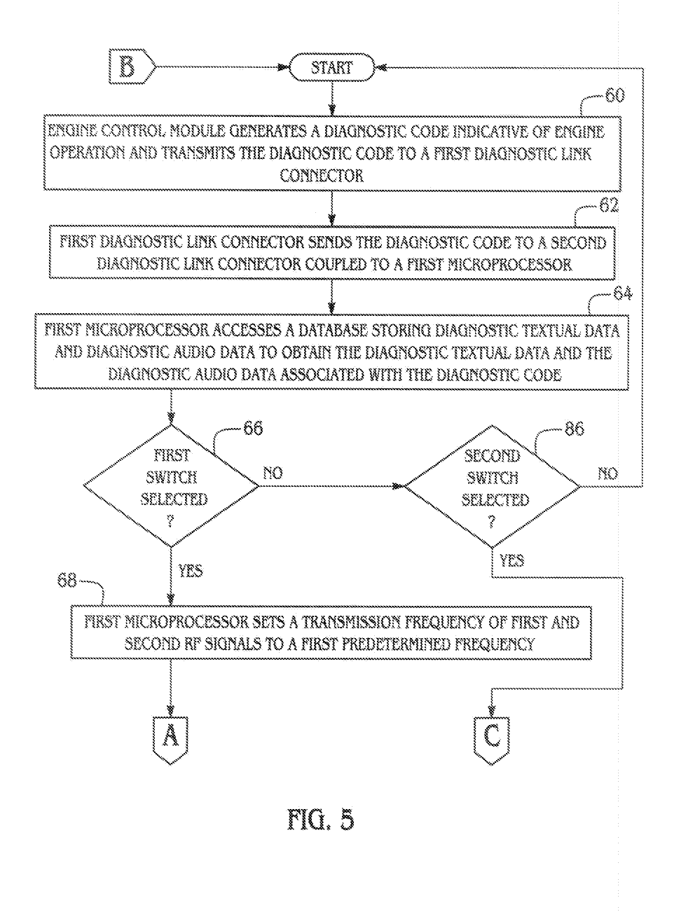

Referring to FIG. 3, for example, when the radio unit 42 receives and RF signal having the diagnostic code “014,” the microprocessor 43 can access the record having diagnostic code “014” in the database 32 to retrieve the diagnostic textual data “low coolant.” Thereafter, the microprocessor 43 can induce the display device 50 to display the diagnostic textual data “low coolant.”

Referring to FIG. 1, the vehicle diagnostic code communication device 24 further includes an RF transmitter 34 operably coupled to the microprocessor 28. The microprocessor 28 is configured to induce the RF transmitter 34 to transmit an RF signal having diagnostic audio data associated with the received diagnostic code. The vehicle diagnostic code communication device 24 further includes another RF transmitter 36 operably coupled to the microprocessor 28. The microprocessor 28 is further configured to induce the RF transmitter 36 to transmit an RF signal having diagnostic textual data associated with the received diagnostic code. The vehicle diagnostic code communication device 24 further includes a switch 38 operably coupled to the microprocessor 28. The switch 38 is utilized to allow an operator to select a frequency of the RF signals transmitted by the RF transmitters 34, 36. The device 24 further includes a switch 40 operably coupled to the microprocessor 28. The switch 40 is utilized to allow an operator to select a second frequently of the RF signals transmitted by the RF transmitters 34, 36.

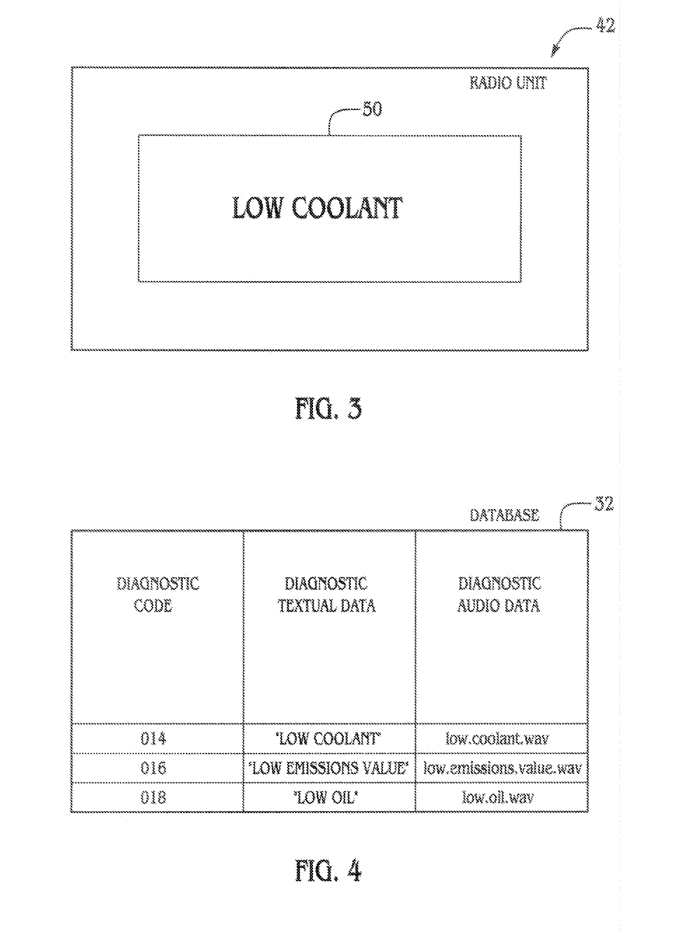

Referring to FIGS. 2 and 3, the radio unit 42 for receiving RF signals from the vehicle diagnostic code communication device 24 is shown. The radio unit 42 includes a microprocessor 43, RF receivers 44, 46, a display device 50, and a speaker device 52. The RF receiver 44 is configured to receive an RF signal having diagnostic textual data from the RF transmitter 36. The RF receiver 46 is configured to receive an RF signal having diagnostic audio data from the RF transmitter 34. The microprocessor 43 is configured to induce the display device 50 to display the diagnostic textual data in an RF signal received by the RF receiver 46. The microprocessor 43 is further configured to induce the speaker device 52 to emit sound corresponding to the diagnostic audio data in an RF signal received by the RF receiver 46.

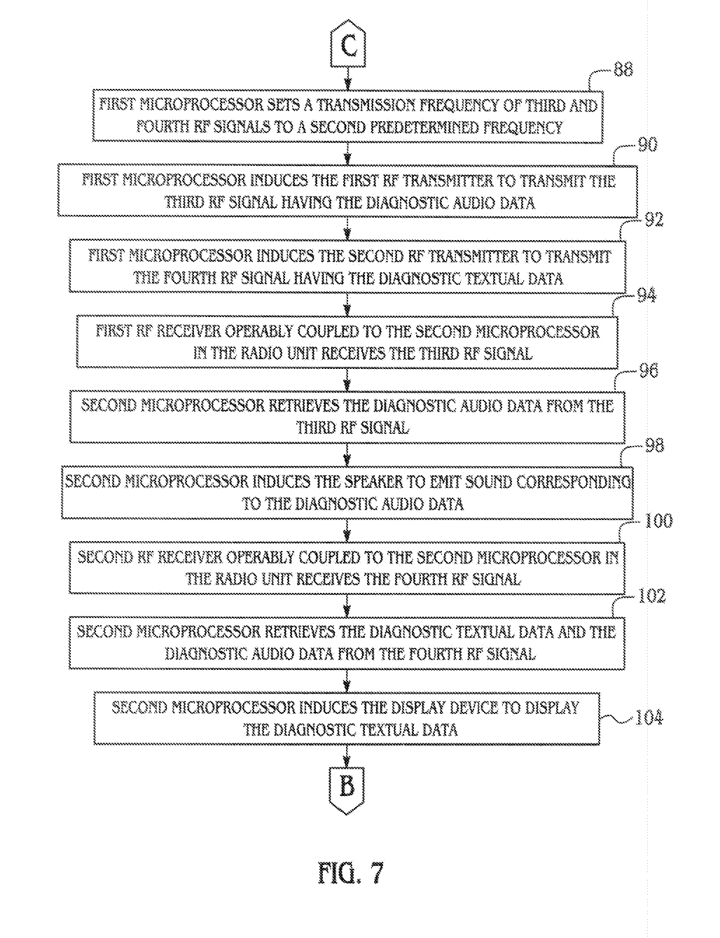

Referring to FIGS. 5-7, a method for transmitting diagnostic data utilizing the vehicle diagnostic code communication system 10 will now be explained.

At step 60, the engine control module 20 generates a signal that is associated with diagnostic code indicative of engine operation and sends the signal to the diagnostic link connector 22.

At step 62, the diagnostic link connector 22 sends the signal associated with the diagnostic code to the diagnostic link connector 26 coupled to the microprocessor 28.

At step 64, the microprocessor 28 accesses the database 32 storing diagnostic textual data and diagnostic audio data to obtain the diagnostic textual data and the diagnostic audio data associated with the diagnostic code.

At step 66, the microprocessor 28 makes a determination as to whether the switch 38 has been closed by a vehicle operator. If the value of step 66 equals “yes,” the method advances to step 68. Otherwise, the method advances to step 86.

At step 68, the microprocessor 28 sets a transmission frequency of first and second RF signals to a first predetermined frequency.

At step 70, the microprocessor 28 induces the RF transmitter 34 to transmit the first RF signal having the diagnostic audio data.

At step 72, the microprocessor 28 induces the RF transmitter 36 to transmit the second RF signal having at the diagnostic textual data.

At step 74, the receiver 42 operably coupled to the microprocessor 43 in the radio unit 42 receives the first RF signal.

At step 76, the microprocessor 43 retrieves the diagnostic audio data from the first RF signal.

At step 78, the microprocessor 43 induces the speaker 52 to emit sound corresponding to the diagnostic audio data.

At step 80, the RF receiver 46 operably coupled to the microprocessor 43 in the radio unit 42 receives the second RF signal.

At step 82, the microprocessor 43 retrieves the diagnostic textual data from the second RF signal.

At step 84, the microprocessor 43 induces the display device 50 to display the diagnostic textual data. After step 84, the method returns to step 60.

Referring again to step 66, if the value of step 66 equals “no,” the method advances to step 86.

At step 86, the microprocessor 28 makes a determination as to whether the switch 40 has been closed by a vehicle operator. If the value of step 86 equals “yes,” the method advances to step 88. Otherwise, the method returns to step 60.

At step 88, the microprocessor 28 sets a transmission frequency of third and fourth RF signals to a second predetermined frequency.

At step 90, the microprocessor 28 induces the RF transmitter 34 to transmit the third RF signal having the diagnostic audio data.

At step 92, the microprocessor 28 induces the RF transmitter 36 to transmit the fourth RF signal having the diagnostic textual data.

At step 94, the RF receiver 44 operably coupled to the microprocessor 43 in the radio unit 42 receives the third RF signal.

At step 96, the microprocessor 43 retrieves the diagnostic audio data from the third RF signal.

At step 98, the microprocessor 43 induces the speaker 52 to emit sound corresponding to the diagnostic audio data.

At step 100, the RF receiver 46 operably coupled to the microprocessor 43 in the radio unit 42 receives the fourth RF signal.

At step 102, the microprocessor 48 retrieves the diagnostic textual data and the diagnostic audio data from the fourth RF signal.

At step 104, the microprocessor 43 induces the display device 50 to display the diagnostic textual data. After step 104, the method returns to step 60.

The vehicle diagnostic code communication device and the method for transmitting diagnostic data represent a substantial advantage over other devices and methods. In particular, the vehicle diagnostic code communication device and method provide a technical effect of transmitting RF signals having diagnostic data.

While the invention has been described with reference to exemplary embodiments, it will be understood by those skilled in the art that various changes may be made and equivalents may be substituted for elements thereof without departing from the scope of the invention. In addition, may modifications may be made to adapt a particular situation or material to the teachings of the invention without departing from the essential scope thereof. Therefore, it is intended that the invention not be limited to the particular embodiment disclosed for carrying this invention, but that the invention will include all embodiments falling within the scope of the appended claims. Moreover, these of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A vehicle diagnostic code communication device, comparing:
a diagnostic link connector configured to receive signals indicating a diagnostic code associated with vehicle operation;
a first microprocessor operably coupled to the diagnostic link connector, the first microprocessor configured to determine at least one of diagnostic textual data and diagnostic audio data based on the diagnostic code; and
a first RF transmitted operably coupled to the first microprocessor, the first microprocessor further configured to induce the first RF transmitter to transmit a first RF signal having at least one of the diagnostic textual data and the diagnostic audio data.

2. The vehicle diagnostic code communication device as set forth in claim 1, wherein the first microprocessor is further configured to retrieve the diagnostic textual data and the diagnostic audio data from a database utilizing the diagnostic code.

3. The vehicle diagnostic code communication device as set forth in claim 1, further comprising a second RF transmitter operably coupled to the first microprocessor, the first microprocessor further configured to induce the second RF transmitter to transmit a second RF signal having at least one of the diagnostic textual data and the diagnostic audio data.

4. The vehicle diagnostic code communication device as set forth in claim 1, further comprising at least a first switch operably coupled to the first microprocessor, the first switch being utilized to select a first frequency of the first RF signal.

5. A method for transmitting diagnostic data utilizing a vehicle diagnostic code communication device, the vehicle diagnostic code communication device having a diagnostic link connector, a first RF transmitter, a first microprocessor operably coupled to the diagnostic link connector and the first RF transmitter, the method comprising:
receiving a diagnostic code at the diagnostic link connector;
determining at least one of the diagnostic textual data and diagnostic audio data based on the diagnostic code, utilizing the first microprocessor; and
inducing the first RF transmitter to transmit a first RF signal having at least one of the diagnostic textual data and the diagnostic audio data, utilizing the first microprocessor.

6. The method as set forth in claim 5, further comprising retrieving at least one of diagnostic textual data and diagnostic audio data from a database based on the diagnostic code, utilizing the first microprocessor.

7. The method as set forth in claim 5, further comprising inducing a second RF transmitter to transmit a second RF signal having at least one of the diagnostic textual data and the diagnostic audio data, utilizing the first microprocessor.

8. The method as set forth in claim 5, further comprising actuating a switch operably coupled to the first microprocessor to select a frequency of the first RF signal.

9. The method as set forth in claim 5, further comprising:
receiving the first RF signal at a first RF receiver, the first RF signal having the diagnostic textual data;
retrieving the diagnostic textual data from the first RF signal, utilizing a second microprocessor operably coupled to the first RF receiver; and
displaying the diagnostic textual data on a display device operably coupled to the second microprocessor.

10. The method as set forth in claim 5, further comprising:
receiving the first RF signal at a first RF receiver, the first RF signal having diagnostic audio data;
retrieving the diagnostic audio data from the first RF signal, utilizing a second microprocessor operably coupled to the first RF receiver; and
emitting sound corresponding to the diagnostic audio data utilizing a speaker operably coupled to the second microprocessor.
